(19) United States
(12) Patent Application Publication
(10) Pub. No.: US 2010/0011091 A1
(43) Pub. Date: Jan. 14, 2010

(54) Network Storage

(75) Inventors: David C. Carver, Lexington, MA (US); Branko J. Gerovac, Lexington, MA (US)

Correspondence Address: OCCHIUTI ROHLICEK & TSAO, LLP, 10 FAWCETT STREET, CAMBRIDGE, MA, 02138, US

(73) Assignee: Blackwave Inc., Acton, MA (US)

(21) Appl. No.: 12/170,769

(22) Filed: Jul. 10, 2008

(51) Int. Cl. G06F 15/16

(52) U.S. Cl. 709/219

(57) ABSTRACT

Systems, methods, and apparatus including computer program products to receive a data transfer request that includes a specification of an access operation to be executed in association with one or more network-based storage resource elements, the specification including respective persistent fully-resolvable identifiers for the one or more network-based storage resource elements, and process the access operation in accordance with its specification to effect a data transfer between nodes on a data network.

### BACKGROUND

This specification relates to network storage.

Distributed data storage systems are used today in a variety of configurations. For example, a storage area network (SAN) is used to couple one or more server computers with one or more storage devices. In some cases, an Internet SCSI (iSCSI) protocol is used in which each server has an initiator, which provides a local interface to remote storage units at target storage devices. The servers can effectively use the remote storage as if it were local to those servers.

Other distributed storage systems, such as the Amazon S3 system, make use of Web-based protocols to provide storage services to remote clients. For example, a user can read, write, or delete files stored in a remote Internet accessible storage system.

In such distributed storage systems, the access requests made by a client of the system may be abstracted such that physical arrangements of data on storage devices, such as disks and the use of buffers is hidden from the user, is not visible to the client.

### SUMMARY

In general, in one aspect, the invention features a computer-implemented method that includes receiving a data transfer request that includes a specification of an access operation to be executed in association with one or more network-based storage resource elements, wherein the specification includes respective persistent fully-resolvable identifiers for the one or more network-based storage resource elements, and processing the access operation in accordance with its specification to effect a data transfer between nodes on a data network.

Aspects of the invention may include one or more of the following features.

The data transfer request may be received from a first node on the data network and the processing of the access operation affects a data transfer between the first node and a second node on the data network.

The first node may manage a first set of network-based storage resource elements, one of which is associated with a first persistent fully-resolvable identifier provided in the specification, and the second node may manage a second set of network-based storage resource elements, one of which is associated with a second persistent fully-resolvable identifier provided in the specification.

The element of the first set, which is associated with the first persistent fully-resolvable identifier, may represent a data source of the data transfer request, and the element of the second set, which is associated with the second persistent fully-resolvable identifier, may represent a data destination of the data transfer request.

The element of the first set, which is associated with the first persistent fully-resolvable identifier, may represent a data destination of the data transfer request; and the element of the second set, which is associated with the second persistent fully-resolvable identifier, may represent a data source of the data transfer request.

The data transfer request may be received from a first node on the data network and the processing of the access operation effects a data transfer between a second node and a third node on the data network.

The data transfer request may be received by the second node on the data network.

The data transfer request may be received by a fourth node on the data network.

The second node may manage a first set of network-based storage resource elements, one of which is associated with a first persistent fully-resolvable identifier provided in the specification, and the third node may manage a second set of network-based storage resource elements, one of which is associated with a second persistent fully-resolvable identifier provided in the specification.

The specification of the access operation may include a data transfer request type that comprises one of the following: a READ request type, a WRITE request type, a MOVE request type.

The specification of the access operation may further include information that specifies a synchronous or asynchronous nature of the access operation to be executed.

The specification of the access operation may further include information that specifies a time-based period within which the data transfer is to be affected.

The specification of the access operation may further include information that specifies a time-based period within which the access operation is to be executed.

The specification of the access operation may further include information that uniquely identifies a session context within which the access operation is to be executed.

The specification of the access operation may further include information that indicates that the received data transfer request is a last of a set of session-specific data transfer requests.

The specification of the access operation may further include information to prompt a confirmation to be generated upon completion of the data transfer.

The specification of the access operation may further include information to prompt a status update to be generated upon satisfaction of a condition of an event.

Each persistent fully-resolvable identifier for a network-based storage resource element is comprised of a uniform resource identifier (URI).

The data transfer request may be specified in accordance with HTTP syntax or an extension thereof.

In general, in another aspect, the invention features a system that includes nodes on a data network, storage resources that are managed by one or more nodes on the data network, wherein each element of a storage resource is uniquely addressable by a persistent fully-resolvable identifier within the system, and a machine-readable medium that stores executable instructions to cause a machine to receive a data transfer request that includes a specification of an access operation to be executed in association with one or more network-based storage resource elements, wherein the specification includes respective persistent fully-resolvable identifiers for the one or more network-based storage resource elements, and process the access operation in accordance with its specification to effect a data transfer between nodes on a data network.

Each addressable element of a first storage resource may be associated with a name that conforms to a direct addressing scheme that specifies a physical location on the first storage resource.

Each element of a first storage resource may be associated with a name that conforms to an abstract addressing scheme that specifies a logical unit number of the first storage resource.

Each element of a first storage resource may be associated with a name that conforms to an addressing scheme that uses a combination of direct and abstract addressing.

Elements of a first storage resource may be associated with names that conform to a first addressing scheme, and elements of a second storage resource may be associated with names that conform to a second, different addressing scheme.

Aspects can have one or more of the following advantages.

A uniform naming approach, for example based on URI syntax, simplifies coordination of data transfers. For example, session based naming is not required so session-related information is not needed to resolve what storage locations are referenced by a transfer request.

Use of a web-based protocol that allows specification of underlying storage locations, for example based on physical layout of data on storage devices, provides a degree of control to select desired storage characteristics. For example, data may be selective stored on different portions of a disk drive to provide different achievable transfer rates.

Exposing detailed storage characteristics, such as physical storage locations and buffering, can provide more control to performance intensive applications that approaches that abstract the underlying storage approaches.

Using the same protocol at recursive levels of a data transfer request allows introduction of nesting of requests without modification of server interfaces. For example, a direct request from a client to a storage server may be replaced by a request from the client to an aggregation server, which in turn makes multiple separate requests to the storage server to affect the transfer.

Explicit support for three, four, or higher numbers of parties in a data transfer request allows specification of data transfer approaches that avoid data throughput and coordination bottlenecks.

These aspects and features can be used in numerous situations, including, but not limited to, use in Web Attached Storage and/or Representational State Transfer (RESTful) Storage.

Other general aspects include other combinations of the aspects and features described above and other aspects and features expressed as methods, apparatus, systems, computer program products, and in other ways.

Other features and advantages of the invention are apparent from the following description, and from the claims.

### DESCRIPTION OF DRAWINGS

FIG. 1 is a block diagram of a distributed data storage system.

FIG. 2 is a block diagram of a data storage server.

FIG. 3a is a ladder diagram of a basic data transfer flow.

FIG. 3b is a ladder diagram of a basic data transfer flow.

FIG. 4 is a ladder diagram of a complex four-way data transfer flow.

FIG. 5 is a ladder diagram of a complex four-way data transfer flow.

### DESCRIPTION

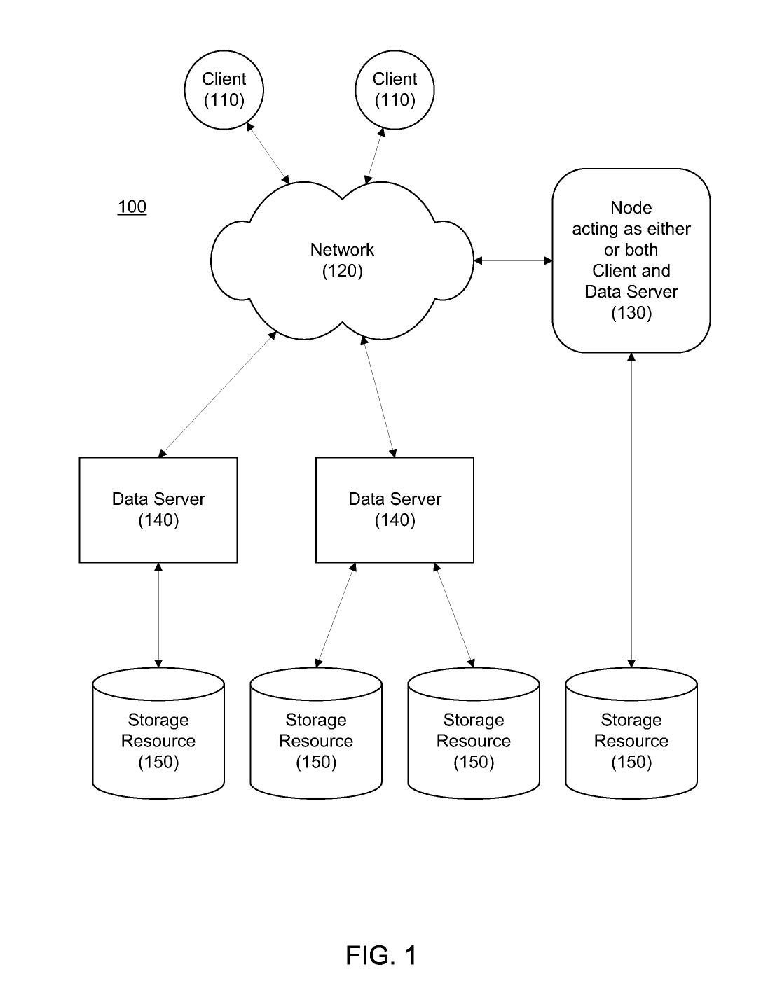

Referring to FIG. 1, a system 100 makes use of network-based storage. A data network 120 links a number of nodes 110, 130, & 140 on the network so that commands and data can be transferred between the nodes. The nodes include a number of data servers 140, which provide mechanisms for storing and accessing data over the network. The nodes also include a number of clients 110, which can take on various roles including initiation of data transfers between nodes, source of data sent to data servers, and destination of data sent from data servers. In some examples, a node can act as either or both a client and a server 130. Note that in this description the term “client” is used more broadly than in the context of a two-party “client/server” interaction. Note that the “nodes” described herein are not necessarily distinct computers on the data network, and may represent component implementing corresponding functions. The components may be hosted together on particular computers on the data network, or whose function is distributed over multiple computers.

Data transactions in the system, in general, involve nodes participating in a transaction taking on one or more roles. These roles include: the requestor of the data transaction, which can be referred to as the “client” role; the coordinator (or “actor”) that controls the transaction, which can be referred to as the “server” role; the source for the data (“data source”); and the destination for the data (“data destination”). As outlined above, a client 110 can, in general, take on the role of a requestor, a data source, or a data destination. For example, in some transactions a single client 110 can take the role of both the requester and either the data source or the data destination for a particular data transaction, while in other transactions, one client can be the requester of a transaction while another client is the data source or data destination. A data server can, in general, take on the role of a coordinator (actor/server), a data source, or a data destination. In some transactions, a single data server 140 can take on the role of both the actor and either the data source or data destination.

A node 130 may take on different rolls in different transactions, or as part of an overall transaction. For example, a node may act as server for one transaction and as a client for another transaction. Because an individual transaction may be part of a larger transaction, a node 130 may act as both client and server over the course of an overall transaction which is carried out as an aggregation of smaller transactions. A node 130 may take on all of the roles (requestor, coordinator, data source, data destination) in a single transaction.

In general, each data server 140 is responsible for managing at least one data storage resource 150, typically a physical data storage medium. Examples of data storage resources include magnetic discs, optical discs, and circuit-based memory. Data storage resources can be volatile or non-volatile. A storage resource may even be one or more other data servers. In FIG. 1, the storage resources 150 are illustrated as separate from the storage servers 140, but it should be understood that a storage resource may be integrated with the storage server (e.g., within a single computer system). Also, the communication link between a storage server 140 and a storage resource 150 may pass over the network 120, or may be entirely separate from the network (e.g., using another network in the system or a direct connection between nodes).

A data server 140 provides access by clients 110 to a storage resource 150 by an addressing scheme associated with that server. Examples of addressing schemes include direct addressing schemes and abstract addressing schemes. An example of a direct addressing scheme is by physical location on a storage resource, such as by specific disk, cylinder, head, and sector. Such direct addressing can give clients express control over data storage locations. Examples of abstract addressing schemes include the use of logical block numbers or other mappings of names spaces onto storage locations. For example, a scheme may use virtual “unit” numbers and allow clients to specify the resource, an offset, and an extent. An addressing scheme for a resource may use a combination of direct and abstract addressing, for example, using a logical unit number, but physical tracks and sectors in the logical unit.

The system 100 uses a globally unique naming scheme where each storage resource, and each addressable portion of each resource, has a globally unique name. The resource addressing scheme used by a data server is unique within the server's namespace. Each server also has a unique identifier. The combination is a globally unique name for each addressable resource. In some examples, the system uses a naming scheme in which a resource address is specified based on a uniform resource identifier (URI), identifying a unique namespace and the unique address within that namespace. In some examples the URI also specifies a network location, e.g., as a uniform resource locator (URL). More information about URIs (and URLs, which are a subset) is available in Uniform Resource Identifier (URI): Generic Syntax, Berners-Lee et al., Internet Engineering Task Force Standard 66, Network Working Group RFC 3986, January 2005.

In general, a URI specifying a portion of a storage resource managed by a storage server include a part that specifies the host name or network address of the storage server, for example, as a name compatible with an Internet Domain Name Server (DNS), which may be used to provide dynamic address translation services. For more information about DNS, see Domain Names—Concepts and Facilities, Mockapetris, Network Working Group RFC 1034, November 1987, and Domain Names—Implementation and Specification, Mockapetris, Network Working Group RFC 1035, November 1987. In one example, the URI also includes a portion that identifies the resource, and a delimiter, such as a query indicator (“?“) or a fragment indicator (“#“) following which a specification of the particular portion of a storage resource is provided. The resource naming schemes may also incorporate versioning information for extensibility. In some examples, a session naming scheme is incorporated into the URI.

An example URI address is:
http://server1.example.com/unit1#0-1000000
   In this example,
the URI-scheme, http, identifies that the access protocol follows HTTP syntax,
the URI-host, server1.example.com, identifies the data server (this could also be in the form of an IP address, e.g. 10.0.0.1),
the last URI-path segment, unit1, identifies the resource (e.g. a disk),
the URI fragment indicator, #, is used as a delimiter,
the pre-hyphen URI-fragment component, 0, indicates an offset of zero (i.e. the beginning of the resource), and
the post-hyphen URI-fragment component, 1000000, indicates an extent of 1 million bytes.

Another example URI address is:
http://server1.example.com/unit1?offset=0&extent=1000000
   In this example,
the URI-scheme, http, identifies that the name follows HTTP syntax,
the URI-host, server1.example.com, identifies the data server (this could also be in the form of an IP address, e.g. 10.0.0.1),
the last URI-path segment, unit1, identifies the resource (e.g. a disk),
the URI query indicator, ?, is used as a delimiter,
the post-delimiter section is a “query” separated into segments by ampersands (&)
each query-segment has three parts: a label, a separating equal-sign (=), and data
the segment-label “offset” indicates that the segment-data, 0, indicates an offset of zero, and
the segment-label “extent” indicates that the segment-data, 1000000, indicates an extent of 1 million bytes. [Note that other labels could be used for to the same effect, e.g. “o” for offset and “e” for extent.]

Another example URI address is:
http://server1.example.com/unit1/0/1000000
   In this example,
the URI-scheme, http, identifies that the name follows HTTP syntax,
the URI-host, server1.example.com, identifies the data server (this could also be in the form of an IP address, e.g. 10.0.0.1),
the remaining URI-path is composed of three segments:
the first segment, unit1, identifies the resource (e.g. a disk),
the second segment, 0, indicates an offset of zero, and
the third segment, 1000000, indicates an extent of 1 million bytes.

Other URI addressing schemes are also possible.

In general, a storage server 140 performs data storage and retrieval operations for a data transaction initiated by a client 110. In some examples, the transaction is initiated by the client 110 which sends a request (e.g., a message, instruction, command, or other form of communication) specifying the action to be performed and relevant addresses (e.g., a data resource URI for a data source or data destination) associated with the action. A request may also include additional control information. In some examples, some portions of the request are inferred by context. A request protocol can be defined based on the use of URIs. As discussed further below, in some examples the request protocol is defined to make use of the Hypertext Transfer Protocol (HTTP). For more information about HTTP, see Hypertext Transfer Protocol—HTTP/1.1, Fielding et al., World Wide Web Consortium (W3C), Network Working Group RFC 2616, June 1999. The use of HTTP enables simplified operation of network storage devices distributed over a network. For example, HTTP responses are typically sent from the server to the client over a connection in the same order in which their associated requests were received on the connection. The use of HTTP also provides easy firewall traversal, well understood protocol behavior, and simplified server development.

Continuing to refer to FIG. 1, in general, clients 110 submit requests to data servers 140 over the network 120. The requests include requests to store data on storage resources 150 or to retrieve data from the resources.

A write request is a request by a client 110 directed to a data server 140 to store data on a storage resource 150 managed by the data server 140. A write request can be blocking or non-blocking, can require a completion notification or no completion notification, and can use the requesting client 110 as a data source or another node as a data source.

A read request is a request by a client 110 directed to a data server 140 to access data on a storage resource 150 managed by the data server 140. A read request can be blocking or non-blocking, can require a completion notification or no completion notification, and can use the requesting client 110 as a data destination or another node as a data destination.

In some examples, the system supports both synchronous blocking (also referred to as “immediate”) as well as asynchronous non-blocking (or “scheduled”) requests. In an immediate request sent from a client to a data server, the interaction between the client and the data server does not complete until the data transfer itself completes. In an asynchronous request, the interaction between the client and the data server generally completes before the actual data transfer completes. For example, the server may check the validity of the request and return an acknowledgement that the requested data transfer has been scheduled prior to the data transfer having been completed or even begun.

Requests can be framed as a two-party transaction where a requesting client 110 is also either the data source or data destination and a data server 140 is the reciprocal data destination or data source. Such requests can be termed “read” or “write” as appropriate from the perspective of the client. That is, a “read” request initiates a transfer from the data server to the client while a “write” request initiates a transfer from the client to the server. For two-party transactions between a client and a server, in some examples the data being sent from or to the client can be included in the same interaction in which the request itself is provided. For example, a two-party “write” request may include the data to be written as part of an immediate transaction.

A client 110 can also initiate a transaction in which that client is neither the data source nor the data destination. In one such case, the client initiates a three-party transaction in which the client 110 sends a request to a first data server 140 specifying that data is to be transferred between the first data server 140 and a second data server 140. Such requests can be phrased termed “read” or “write” as appropriate from the perspective of the second data server. That is, such a “read” request initiates a transfer from the first data server to the second data server while a “write” request initiates a transfer from the second server to the first server. While the terms “read” and “write” can be used when the requestor is not a data destination and not a data source, the term “move” may also be used. A client 110 sends a “move” request to a data server 140 specifying another data server 140 as either the data source or the data destination. In some examples, a “move” request designates the requester, e.g., to perform a two-party transaction.

In some examples, the system supports four-party transactions in which a client sends a request to a node specifying the data source and the data destination, neither of which is either the initiating client or the node acting on the request. That is, the requester (first party) instructs the coordinator (second party) to move data from a data source (third party) to a data destination (fourth party). This transaction may also be described as a “move.”

In multi-party transactions, in some examples, the data transfer requested by the client can be executed as a separate interaction. For example, in the case of a two-party transaction between a client and a server, the data transfer can be implemented as one or more secondary interactions initiated by the data server using a call-back model. Note that such a separate interaction is in general compatible with both immediate and asynchronous requests. In the case of a multi-party transaction in which the client is neither the data source nor the data destination, the data server can similarly initiate the separate interaction to perform the data transfer requested by the client. Any request in a transaction can be recursively transformed into one or more requests using the same protocol or other protocols. Using the same protocol creates a uniform recursive protocol allowing any one request to be expanded into any number of requests and any number of requests to be aggregated into a single request.

Network storage allows clients to explicitly and specifically control the use of storage resources with a minimum level of abstraction. Traditional resource management responsibilities can be implemented at the server level or abdicated to the user. For example, a server can be implemented without any coherency guarantees and/or without any allocation requirements. Additionally, no requirement is made for the use of sessions, although an implementation may incorporate some notion of session syntax. Event matching can be handled through acknowledgment or event messages. Data servers can also be extended, for example, to support more semantically enhanced storage resources, which may serve roles as buffers and intermediary dynamically created data destinations.

In general, a data server 140 receives requests from a number of different clients 110, with the requests being associated with data transfers to or from a number of clients and/or data servers on the network 120. In different examples of data servers, for example with different examples being used in the same example of the overall system, different scheduling approaches can be used to service the requests from clients. As one example, a first-in-first-out (FIFO) queue of outstanding client requests can be used. Other examples may involve out-of-order and multi-threaded servicing of requests.

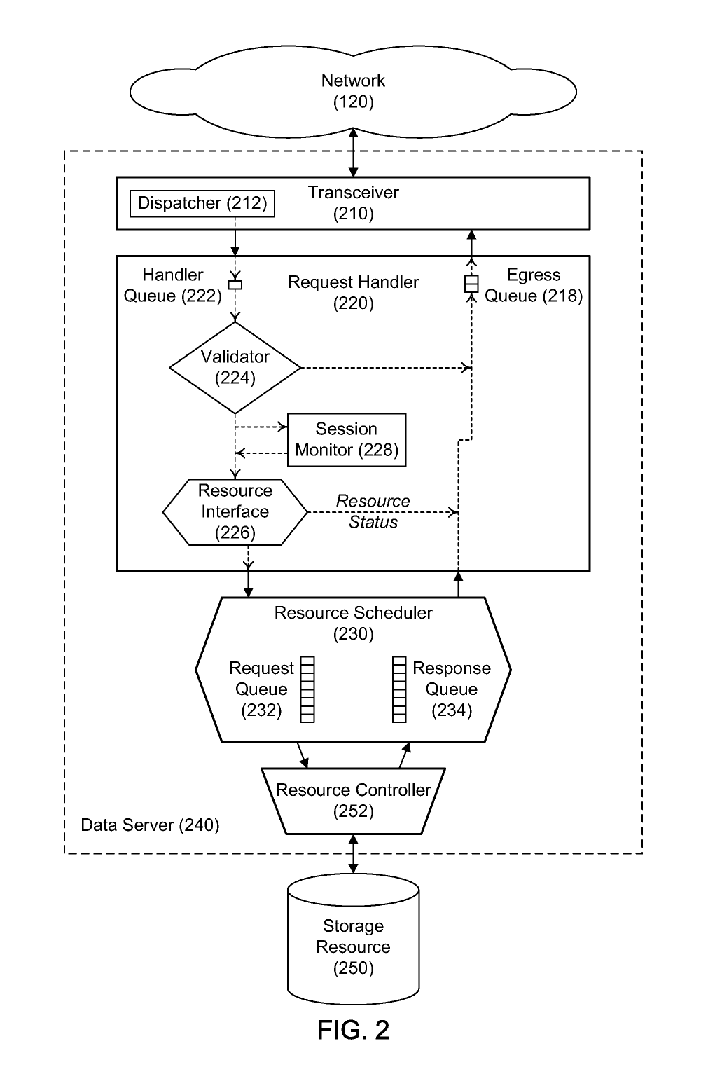

Referring to FIG. 2, in one example, a data storage server 240 manages access to one or more storage resources 250. A resource controller 252 acts as an interface between the storage resource(s) 250 and anything trying to move data. The resource controller 252 may maintain a logical-to-physical address map, if one is used. The resource controller 252 is accessed through a resource scheduler 230 managing a request queue 232 and a response queue 234. The resource scheduler 230 manages the order of the request queue 232. In one embodiment, the queue is operated as a first in, first out (FIFO) queue. In another embodiment, the request queue is managed according to the storage resource. In another embodiment the request queue is managed to meet request constraints, for example processing requests based on when the data transfer should begin or finish (e.g., deadlines). In another embodiment, the request queue is managed to account for both request constraints and resource optimizations. For example, the request queue is treated as a series of time slots or bins. A request that has a deadline within a short period of time goes into the first bin and requests with later deadlines go into later bins. Each time slot, or bin, is then further optimized by resource impact. For example, where the resource is a physical disk, each bin may be organized to optimize seek and rotational delays (e.g., organized such that the disk head does not have to reverse directions while processing the bin). The resource scheduler queues 232 and 234 may, for example, be implemented with circuit-based memory. If the resource scheduler becomes overloaded, for example, requests exceed the available memory space, requests are rejected with an appropriate status notification (e.g., “resource busy”).

Resource requests are processed by a request handler 220. The request handler 220 works from a handler queue 222. Each request is parsed and validated 224 and then submitted to the appropriate resource interface 226. Resource interface 226 submits the request to a resource scheduler. Either a resource status (e.g., request scheduled/resource busy) or a response (e.g., request complete) is then returned via an egress queue 218. In some embodiments, additional features make use of sessions, which are monitored by session monitor 228.

Communication between a data server 240 and a requester is carried by data network 120. The data server 240 includes a transceiver 210 for handling network connections and communication. Requests arrive at the transceiver 210 and are sent to a request handler 220 via a dispatcher 212. One data server 240 may have multiple request handlers 220, for example, having one handler for each available processing core. Dispatcher 212 selects a request handler 220 for each request, placing the request in the selected hander's queue 222. Selection can be determined, for example, by next available handler. In some embodiments, specialized handlers expect to process specific types or forms of requests. The dispatcher 212, in these embodiments, accordingly selects the request handler based on request type or form. This is done, for example, by using specific ports for specialized requests. Specialized requests might be alternative request formats or a restricted sub-set of the generalized format used by the embodiment. Multiple request handlers, some or all of which are specialized, can be used to distribute the data server work load.

A data server can process requests from multiple clients. In some embodiments, when a client writes data to a server, it may create a conflict with other requests. For example, the result of reading data from an address is dependant on what data was last written to that address. When a read and a write request arrive concurrently, the order in which they are executed will impact the result of the read operation. This is known as a data coherency problem. A data server may be implemented to address coherency concerns, for example by restricting access to a resource to a single session and strictly ordering requests within that session. A sufficiently strict ordering is to require that a server handle an operation only after any previously received write operation in the same address space has finished. An access manager may be employed to prevent clients from unexpectedly blocking other clients or creating a resource deadlock.

In some embodiments, a data server can process requests from multiple clients with no coherency checking between clients, or within requests from a single client. Such an approach moves management of these concerns outside the scope of the data servers, providing greater flexibility in the implementation of the data servers, which may potentially increase performance of the overall system.

In an implementation where a data server has multiple handlers, there may be potential for an additional coherency problem within requests of a single client. In some embodiments, requests from a single connection are processed such that coherency concerns are avoided. For example, all requests on a connection are dispatched to the same handler. In some examples, a handler can inspect each request and look across all other handlers for a conflict and stall the handler until the conflict clears.

The communication network 120 is any network of devices that transmit data. Such network can be implemented in a variety of ways. For example, the communication network may include one of, a combination of, an Internet, a local area network (LAN) or other local network, a private network, a public network, a plain old telephone system (POTS), or other similar wired or wireless networks. The communication network can also include additional elements, for example, communication links, proxy servers, firewalls or other security mechanisms, Internet Service Providers (ISPs), gatekeepers, gateways, switches, routers, hubs, client terminals, and other elements. Communications through the communication network can include any kind and any combination of communication links such as modem links, Ethernet links, cables, point-to-point links, infrared connections, fiber optic links, wireless links, cellular links, Bluetooth®, satellite links, and other similar links. The transmission of data through the network can be done using any available communication protocol, such as TCP/IP. Communications through the communication network may be secured with a mechanism such as encryption, a security protocol, or other type of similar mechanism.

Data servers manage access to data resources. When a request arrives at a server to use that resource, the data server either performs the request immediately or schedules one or more future operations to satisfy the request. If the server can't do one of these things it responds to a request with a rejection or error message. A request that can be satisfied with one or more future operations is an asynchronous request. An asynchronous request may be performed immediately or it can be scheduled, e.g., posted to a work queue for later execution.

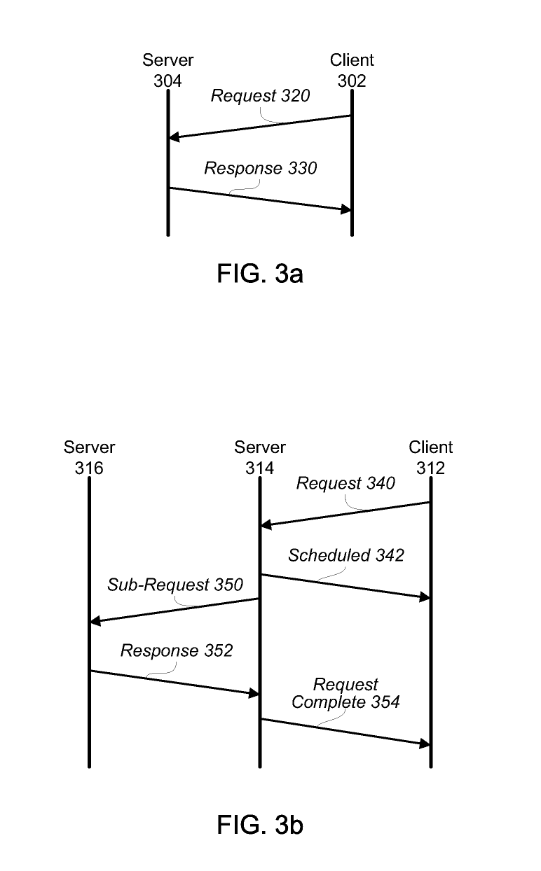

Referring to FIG. 3a, a client 302 submits a request 320 to a server 304. The server 304 process the request and submits a response 330 to the client 302. The request 320 may be to write data accompanying the request, in which case the response 330 may be a confirmation or an error message. The request 320 may be to read data identified by the request, in which case the response 330 may be the data itself or an error message. Other requests are also possible.

Referring to FIG. 3b, a client 312 submits a three-party request 340 to a first server 314. The server 314 may respond with a message indicating that the request is scheduled 342 or with an error message, or even no response at all. Server 314 performs the requested operation, for example by sending a sub-request 350 to a second server 316 and processing a response 352 from the second server 316. Once completed, the server 314 may, in some examples, send a completion message 354 to the client 312. The request is asynchronous if the client 312 does not block waiting for completion.

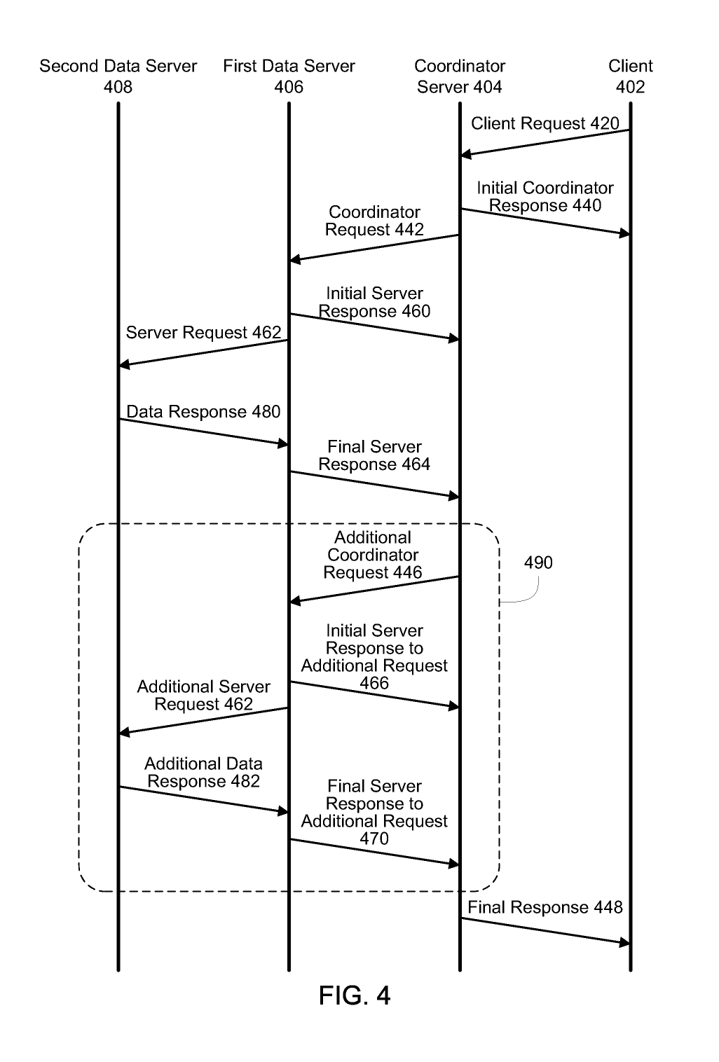

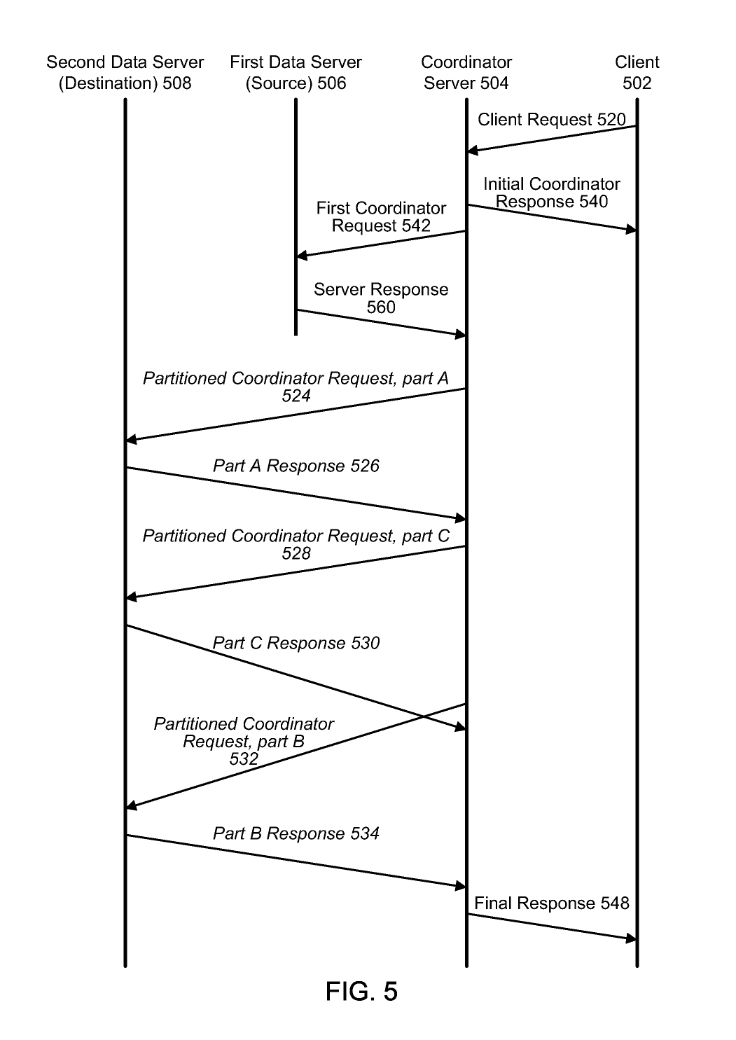

In some examples, the server 314 may use multiple sub-requests 350 to complete the initial request 340. In some situations, the multiple sub-requests are executed in or potentially out of order, for example, to balance the network traffic load or to optimize the performance of storage resources. This is demonstrated further using four-party examples further below, in reference to FIG. 4 and FIG. 5.

Requests may be executed within the context of a session, which may be logical or explicit. A session is a relationship between a client and server. It is independent of what connection or set of connections two devices use to communicate. Sessions may be used, for example, to manage the use of ephemeral server resources by a set of requests. Ephemeral server resources used by the set of requests are bound to a session. When, in this example, a session terminates, resources bound to the session are released. In some embodiments, a session may be identified by a unique name, which can be formed as a URI.

For example, a session might be named:
http://server1.example.com/sessions/049AF012
   In this example,
the URI-scheme, http, identifies that the name follows HTTP syntax,
the URI-host, server1.example.com, identifies the data server (this could also be in the form of an IP address, e.g. 10.0.0.1),
the URI-path segment, sessions, identifies the URI as a session,
the last URI-path segment, 049AF012, is an example session ID within the server1 namespace.

In one example implementation, the data transfer operations can be defined using the HTTP protocol. Quoting section 1.4 of the HTTP RFC (2616): “The HTTP protocol is a request/response protocol. A client sends a request to the server in the form of a request method, URI, and protocol version, followed by a MIME-like message containing request modifiers, client information, and possible body content over a connection with a server. The server responds with a status line, including the message's protocol version and a success or error code, followed by a MIME-like message containing server information, entity meta-information, and possible entity-body content.” The MIME-like message is the body of the request and can include custom parameters. The example protocol used here uses this space to include the parameters of data transfer operations.

Read, write, and move requests can be formed as an HTTP request. HTTP POST, GET, or PUT may be used. The parameters included with the request characterize the request. Request parameters can be, for example, part of the HTTP request header (e.g., for a POST request) or, in another example, as part of the request URL (e.g., as segments following a query indicator). The recommended parameters are:
REQUEST={“MOVE”|“READ”|“WRITE”}
SOURCE=URI
DESTINATION=URI
ASYNC={“TRUE”|“FALSE”|}
DEADLINE=TimeInterval
SESSION=URI
COMPLETE={“TRUE”|“FALSE”}
CONFIRM=URI

The REQUEST parameter specifies the request type. In some embodiments, the values are “MOVE”, “READ”, and “WRITE”. In some embodiments, since the different data transfer request types can be distinguished by the parameters, e.g., source and destination, the request is simply a “MOVE”. In some embodiments, there is no REQUEST type. For example, all requests without a request type are treated as a MOVE. In another example, HTTP GET and HTTP PUT are used to provide indication of the request. For example, a GET can indicate a READ and a PUT can indicate a WRITE. In some embodiments, the ASYNC parameter is used to distinguish the synchronous and asynchronous versions. In some embodiments, all requests are asynchronous, eliminating the need for the ASYNC parameter.

The SOURCE parameter specifies a URI address for the data source to be used in operations satisfying the request. A write request may include the data to be written rather than specify a source address. In embodiments using HTTP GET and HTTP PUT to indicate the request type, the SOURCE may be implied. A GET implies that the coordinator is the source and a PUT implies the requester is the source. The SOURCE parameter can be used to override the implication.

The DESTINATION parameter specifies a URI address for the data destination to be used in operations satisfying the request. The coordinator should reject a request if the destination address indicates a space smaller than the data to be transferred. On a read operation, the data can be included in the response. In embodiments using HTTP GET and HTTP PUT to indicate the request type, the DESTINATION may be implied. A GET implies that the requester is the destination and a PUT implies the coordinator is the destination. The DESTINATION parameter can be used to override the implication.

The ASYNC parameter is not always required. It is used to differentiate asynchronous requests from synchronous request when this is not clear from the REQUEST parameter or HTTP request type. If set to “TRUE”, it indicates an asynchronous request. If set to “FALSE”, it indicates a synchronous request. POST may be defaulted to either “TRUE” or “FALSE” depending on the implementation. If a request with ASYNC set to “TRUE” is missing a necessary source or destination (either explicit or properly implied), no data transfer is performed. The coordinator may, however, interpret this action as a hint from the requester that the requester may subsequently use some or all of the requested resource.

The DEADLINE parameter is not required. It is used to specify a “need within” time for scheduling purposes. If a requester specifies a deadline, the coordinator must reject the request if the coordinator is unable to schedule the request so as to meet the deadline. The parameter value is TimeInterval, which is a number specifying an amount of time. By accepting a request with a deadline, the coordinator is promising to complete the requested operating operation before that amount of time has elapsed. It is up to the requester to compensate, if necessary, for expected network latency in transferring the request to the coordinator. It is up to the coordinator to compensate, if necessary, for expected network latency in transferring the data. If the coordinator does not complete the data transfer in the time indicated, it may continue trying or it may terminate the operation and notify the requester with an appropriate error event. The deadline is not necessarily a timeout requirement. The deadline conveys scheduling information from the requester to the coordinator.

The SESSION parameter is not required. When a session URI is supplied, the coordinator executes operations satisfying the request within the context of the given session. If no session is given, the default session context is used.

The COMPLETE parameter is not required. When a session URI is supplied and the complete parameter is set to “TRUE” it indicates that the request is the last in a set of related requests on the connection.

The CONFIRM parameter is not required. When a confirmation URI is supplied, the coordinator will send a message containing the request message expression to the confirmation resource identified by the URI when the request has been satisfied. When the destination is persistent storage, the confirm message will only be sent when the data is persistently stored.

In an example embodiment using an HTTP implementation, the request parameters are placed in the MIME-like body of the request or in the URL as, for example, fragments following a request indicator. An example of an HTTP POST request for a MOVE using the MIME-like body resembles:

“POST /V01.01/unit/” SP S-URL SP “HTTP/1.1”
“Host: “ <aaa.bbb.ccc.ddd>:<ppppp>
“Content-Length: ” 20*DIGIT

| | |
|---|---|
| “Source: ” A-URL | // NULL URL indicates no explicit Source |
| “Destination: ” A-URL | // NULL URL indicates no explicit Destination |
| “Confirm: ” A-URL | // NULL URL indicates no explicit Confirm |

“Content-Range: “bytes” SP Start “-” End “/*”

| | |
|---|---|
| where: | Start = 20*DIGIT |
| | End = 20*DIGIT |

```
“Content-Type: application/octet-stream”
“Status: ” = “200 OK” | “400 Bad Request” | “404 Not Found” |
  “499 Request Aborted”500 Internal Server Error” |
  “500 Internal Server Error” | NULL
```

Note that the S-URL in the first line specifies the coordinator of the operation. If Source, Destination, or Confirm are NULL, they default to the S-URL. For example, a POST without a source means the source URL is specified by S-URL. An example S-URL format is as follows.

/unit/UNIT?offset=OFFSET&extent=EXTENT&deadline=DEADLINE
&async=BOOL
where:
UNIT = 10*DIGIT
OFFSET = 20*DIGIT
EXTENT = 20*DIGIT
DEADLINE = 10*DIGIT
BOOL = “true” | “false”

Note also that the fixed length fields shown in these examples (indicated, e.g., as 10*DIGIT or 20*DIGIT) are not a requirement. They are an example of how the HTTP syntax can be constrained in a backwards compatible manner to optimize for very high performance processing. A more extensible variable-length embodiment is also envisioned.

Abort requests can also be formed as an HTTP request. The recommended parameters are:
REQUEST=“ABORT”
DESTINATION=URI
SESSION=URI

The REQUEST parameter specifies the request type as an abort. An abort operation performs a best effort termination of previously transmitted requests to a resource.

The DESTINATION parameter specifies a URI address for the resource. When an abort request is received, outstanding transfer operations to that resource are either allowed to complete or are terminated. The coordinator should abort operations only to the degree that it can do so without undue complexity and/or adverse performance effects. Removing a pending operation from a schedule queue is equivalent to terminating the operation. The response to an abort request indicates which outstanding operations were terminated.

The SESSION parameter is not required. When a session URI is supplied, the coordinator should attempt to abort requests bound to the given session. If no session is given, the coordinator should attempt to abort requests bound to the default session.

Event messages can also be formed as an HTTP request. The recommended parameters are:
REQUEST=“EVENT”
RESOURCE=URI
STATUS={“CONFIRM”|“FAILURE”|“RETRY”|“ABORT”|“BUSY”}
SESSION=URI

The REQUEST parameter specifies the request type as an event. An event operation is a message exchange originated by the coordinator to a requesting device indicating the presence of a status condition in the execution of an asynchronous request. The request parameter can be an optional parameter if event is used as a default request type.

The RESOURCE parameter specifies the relevant resource for the message, either the source or destination of the asynchronous operation resulting in the event.

The STATUS parameter indicates the condition of the event. The list supplied is not exhaustive. The status parameter can be implemented as an extensible enumeration indicating the abnormal condition. The examples given may indicate:
CONFIRM—the requested operation is confirmed complete
FAILURE—the requested operation has terminated without completing
RETRY—the coordinator has encountered problems in performing the requested operation, but it is continuing to attempt the operation
ABORT—the requested operation was terminated because of an ABORT operation
BUSY—the coordinator is unable to schedule or complete the requested operation because it is overloaded

The SESSION parameter is not required. When a session URI is supplied, it indicates the session of the asynchronous operation resulting in the event.

Additional requests can also be used for allocating space on a resource, establishing buffers, or other operations supported by data servers.

A coordinator can meet the obligations of an asynchronous transfer by performing one or more blocking transfers. It can initiate its own asynchronous transfer. It can even use an alternative transfer protocol, for example iSCSI or PCI Express. The coordinator is only obligated to attempt the transfer and to manage requests so that transfers are completed by their associated deadlines. Note that operations may be recursively transformed into constituent operations. A single operation from one node's perspective may be transformed into a multiple operations. Multiple operations may be transformed into a single operation. The original and the transformed operations may use the same URI-based protocol. For example, a coordinator may instruct a destination server to read data from a source server. The destination server may actually perform a set of read operations that, put together, would constitute the requested read. In another example, a client may submit a set of write requests to a coordinator server, where the data is to be written to a destination server. The coordinator may aggregate the write requests into a single write request to the destination server. Any request may be handled in this matter. In some cases, the recursion will be very deep with a series of servers each passing requests to other servers.

Referring to FIG. 4, as an example of a four party transaction, a requester client 402 can request that a coordinator server 404 manage the transfer of data between a first data server 406 and a second data server 408 where the data does not necessarily pass through the coordinator 404. In this example, the client request 420 might simply be to move the data by a deadline. After receiving a confirmatory response 440, the client may assume that the request will be satisfied. Coordinator server 404 then issues a set of requests to conduct the data transfer. For example, an initial request 442 is sent to the first data server 406, which is confirmed or rejected by an initial server response 460. In some examples, no response is sent until the requested transaction is complete. The first data server 406 performs the requested transaction by sending a request 462 to the second data server 408. That request is replied to with a data response 480. For example, if the server request 462 was a READ, the data response 480 might be the data itself. In another example, if the server request 462 was a WRITE, the data response 480 might be a confirmation. The response 480 may alternatively be an error message. The first data server 406 may also send a final server response 464 to the coordinator 404.

The coordinator 404 may issue any number of additional requests 446 as it coordinates the transaction. Each additional request will follow a similar pattern 490, with a possible initial server response to the additional request 466, an additional server request 468, additional data response 482, and a final server response to the additional request 470. Note that any one request may be recursively transformed into one or more new requests satisfying the one request. Likewise, any number of requests may be aggregated into one request. Also, the four roles (client, coordinator, source, and destination) may be four separate systems or some systems may take on multiple roles. That is, the four parties can reside in one, two, three, or four physical locations.

When the entire transaction is complete, the coordinator may send a final response 448 to the client 402. The final response 448 may indicate that the original client request 420 has been satisfied, or that there was an error. In some implementations there is no final response 448. In some implementations there is only a final response 448 in error conditions. This transaction may take place in the context of a session.

Referring to FIG. 5, in a more specific example, requester client 502 sends a client request 520 to a coordinator server 504. In this example, the request 520 is for data to be moved from a source, first data server 506, to a destination, second data server 508. The coordinator 504 may send an initial coordinator response 540 to the client 502, for example, to confirm or reject the request 520. The coordinator 504 determines how best to achieve the move, and in this example it decides to move the data from the source 506 to the destination 508 via itself. This may be, for example, because no better (e.g., faster) data path exists between the two servers. It may be, for another example, because causing the data to flow directly from the source 506 to the destination 508 would slow down the better paths in an unacceptable manner. Whatever the particular reason, coordinator server 504 sends a first MOVE (or, READ) request 542 to first data server 506. First data server 506 responds 560 with either an error message or the requested data. The coordinator server 504 then writes the data to the second data server 508.

Note that this example demonstrates partitioning this action into a set of partitioned coordinator requests (A, B, & C), which may be formed as a MOVE or a WRITE. The number of partitions is only an example; in practice any number of partitions can be used. Some partitioned requests may even take alternative routes and/or be formed as four-party requests with the coordinator server 504 acting as the client. In this example the three partitions are sent out of order (A, C, & B) and in a manner demonstrating that the requests do not need to be serialized or made to wait for responses. Specifically, in this example, part A 524 is sent to second data server 508 and the second data server 508 replies with part A response 526. The response, for example, may be a confirmation or an error message. In some implementations there is no response or there is only a response in an error situation. Coordinator server 504 sends partitioned coordinator request part C 528 and the second data server 508 replies with part C response 530. In this example there is no need for the coordinator server to wait for the response. It may send additional requests, e.g., partitioned coordinator request part B 532, before receiving confirmation messages, e.g., part C response 530. The coordinator server 504 sends partitioned coordinator request part B 532 and the second data server 508 responds with part B response 534.

After satisfying the client request 520, coordinator server 504 may send a final response 548 to the client 502. The response 548 may be a confirmation of success or an indication of error. This transaction may take place in the context of a session.

Data servers may also support client-allocated buffer elements to provide for the explicit use of data resources in staging data transfers. The protocol presented above can be extended to allow clients to allocate buffer resources. In a buffering arrangement requestors are able to request the use of a buffer, control the creation and life of a buffer, continue to directly address storage resources, and directly address a buffer. Direct addressing of a buffer allows the buffer, once established, to be used like any other storage resource, albeit within the constraints of the buffer. A buffer can be tied to a session and released when the session is terminated. Buffers may have associated semantics, for example, queuing semantics, reducing the communication and synchronization needed to complete a complex transaction. A buffer might be used to stage a transfer where the available bandwidth isn't uniform, where the source and eventual destination are geographically far apart, or where the availability of a resource has additional constraints such as availability or speed. Other uses also include keeping the size of disk allocation units independent from the size of buffers used elsewhere in the system. Buffers, and other dynamically created storage resources, may be used for other purposes as well, for example, optimizing content availability for a particular usage pattern.

The system and all of the functional operations described in this specification can be implemented in digital electronic circuitry, or in computer hardware, firmware, software, or in combinations of them. The system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the system can be performed by one or more programmable processors executing a computer program to perform functions of the system by operating on input data and generating output. Method steps can also be performed by, and apparatus of the system can be implemented as, special purpose logic circuitry, e.g., a field programmable gate array (“FPGA”) or an application-specific integrated circuit (“ASIC”).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

It is to be understood that the foregoing description is intended to illustrate and not to limit the scope of the system, which is defined by the scope of the appended claims. Other embodiments are within the scope of the following claims.

What is claimed is:

1. A computer-implemented method comprising:
receiving a data transfer request that includes a specification of an access operation to be executed in association with one or more network-based storage resource elements, wherein the specification includes respective persistent fully-resolvable identifiers for the one or more network-based storage resource elements; and
processing the access operation in accordance with its specification to effect a data transfer between nodes on a data network.

2. The computer-implemented method of claim 1, wherein the data transfer request is received from a first node on the data network and the processing of the access operation affects a data transfer between the first node and a second node on the data network.

3. The computer-implemented method of claim 2, wherein:
the first node manages a first set of network-based storage resource elements, one of which is associated with a first persistent fully-resolvable identifier provided in the specification; and
the second node manages a second set of network-based storage resource elements, one of which is associated with a second persistent fully-resolvable identifier provided in the specification.

4. The computer-implemented method of claim 3, wherein:
the element of the first set, which is associated with the first persistent fully-resolvable identifier, represents a data source of the data transfer request; and
the element of the second set, which is associated with the second persistent fully-resolvable identifier, represents a data destination of the data transfer request.

5. The computer-implemented method of claim 3, wherein:
the element of the first set, which is associated with the first persistent fully-resolvable identifier, represents a data destination of the data transfer request; and
the element of the second set, which is associated with the second persistent fully-resolvable identifier, represents a data source of the data transfer request.

6. The computer-implemented method of claim 1, wherein the data transfer request is received from a first node on the data network and the processing of the access operation affects a data transfer between a second node and a third node on the data network.

7. The computer-implemented method of claim 6, wherein the data transfer request is received by the second node on the data network.

8. The computer-implemented method of claim 6, wherein the data transfer request is received by a fourth node on the data network.

9. The computer-implemented method of claim 6, wherein:
the second node manages a first set of network-based storage resource elements, one of which is associated with a first persistent fully-resolvable identifier provided in the specification; and
the third node manages a second set of network-based storage resource elements, one of which is associated with a second persistent fully-resolvable identifier provided in the specification.

10. The computer-implemented method of claim 1, wherein the specification includes a data transfer request type that comprises one of the following: a READ request type, a WRITE request type, a MOVE request type.

11. The computer-implemented method of claim 1, wherein the specification of the access operation further includes information that specifies a synchronous or asynchronous nature of the access operation to be executed.

12. The computer-implemented method of claim 1, wherein the specification of the access operation further includes information that specifies a time-based period within which the data transfer is to be affected.

13. The computer-implemented method of claim 1, wherein the specification of the access operation further includes information that specifies a time-based period within which the access operation is to be executed.

14. The computer-implemented method of claim 1, wherein the specification of the access operation further includes information that uniquely identifies a session context within which the access operation is to be executed.

15. The computer-implemented method of claim 1, wherein the specification of the access operation further includes information that indicates that the received data transfer request is a last of a set of session-specific data transfer requests.

16. The computer-implemented method of claim 1, wherein the specification of the access operation further includes information to prompt a confirmation to be generated upon completion of the data transfer.

17. The computer-implemented method of claim 1, wherein the specification of the access operation further includes information to prompt a status update to be generated upon satisfaction of a condition of an event.

18. The computer-implemented method of claim 1, wherein each persistent fully-resolvable identifier for a network-based storage resource element is comprised of a uniform resource identifier (URI).

19. The computer-implemented method of claim 1, wherein the data transfer request is specified in accordance with HTTP syntax or an extension thereof.

20. A system comprising:
nodes on a data network;
storage resources that are managed by one or more nodes on the data network, wherein each element of a storage resource is uniquely addressable by a persistent fully-resolvable identifier within the system; and
a machine-readable medium that stores executable instructions to cause a machine to:
receive a data transfer request that includes a specification of an access operation to be executed in association with one or more network-based storage resource elements, wherein the specification includes respective persistent fully-resolvable identifiers for the one or more network-based storage resource elements; and
process the access operation in accordance with its specification to affect a data transfer between nodes on a data network.

21. The system of claim 20, wherein each addressable element of a first storage resource is associated with a name that conforms to a direct addressing scheme that specifies a physical location on the first storage resource.

22. The system of claim 20, wherein each element of a first storage resource is associated with a name that conforms to an abstract addressing scheme that specifies a logical unit number of the first storage resource.

23. The system of claim 20, wherein each element of a first storage resource is associated with a name that conforms to an addressing scheme that uses a combination of direct and abstract addressing.

24. The system of claim 20, wherein elements of a first storage resource are associated with names that conform to a first addressing scheme, and elements of a second storage resource are associated with names that conform to a second, different addressing scheme.
